(19) United States
(12) Patent Application Publication
(10) Pub. No.: US 2008/0070141 A1
(43) Pub. Date: Mar. 20, 2008

(54) Toner composition having fluorinated polymer additive

(75) Inventors: Maura A. Sweeney, Rochester, NY (US); Grazyna E. Kmiecik-Lawrynowicz, Fairport, NY (US); Robert D. Bayley, Fairport, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 11/524,157

(22) Filed: Sep. 19, 2006

(51) Int. Cl. G03G 9/08

(52) U.S. Cl. 430/108.11; 430/108.6; 430/108.3; 430/108.7; 430/137.14; 430/110.1

(57) ABSTRACT

A toner having a core with at least one resin and at least one colorant, and having on a surface thereof, an additive package including fluorinated polymer particles, and a method of forming toner particles having surface particles attached thereto, wherein the surface particles include fluorinated polymer particles, and the method includes aggregating a material with at least one resin and at least one colorant to produce toner particles, following aggregation, forming a mixture of the surface particles and the toner particles, and subjecting the mixture to a temperature above the glass transition temperature of the toner particles to coalesce the toner particles, whereby the surface particles become at least partially embedded within the surface of the toner particles.

### BACKGROUND

Herein are described toner and developer compositions, and more specifically, color toner and developer compositions containing fluorinated polymer particles as additives. In embodiments, the fluorinated polymer particles are positioned on the toner surfaces. The toner and developer compositions herein can be used in many different types of development systems, and in embodiments, are useful in single component development systems, and in other embodiments, nonmagnetic single component development systems. The toner and developer compositions herein, in embodiments, allow for improved maintenance of end of life. In addition, the compositions herein, in embodiments, have improved anti-blocking/storage characteristics. In embodiments, the toner compositions are prepared via emulsion aggregation processes.

External additives have been used in toner compositions to improve a variety of xerographic properties. As xerographic systems become more complex due to addition of color toner, and as there is an increase in speed of machine, increase in output, and other improvements, more and more additives are being added to the surface of toner to improve the toner product. One problem observed in some toners is that as the toner ages with the larger concentrations, additives lose some of the properties they bring to the toner due to being impacted onto the surface of the toner. Problems also result from the use of many additives on the surface of the toner. The use of too many different types or kinds of additives may increase the likelihood there will be interactions between said additives, reducing their effectiveness. Another recognized problem is how well the additives adhere to the toner. Poor adherence means loose additives in the developer housing or even on the photoreceptor where they will have to be cleaned off. It is also quite expensive to use many additives. In addition, the process of making toner is slowed due to the need to add so many additives.

In addition, there are problems with maintaining end of life. Further, additives can be beaten into the surface (as shown by Scanning Electron Microscopy) thus reducing flow and charging. This leads to print performance problems such as background, mottle, waterfall, and other image defects.

However, by adding a fluorinated polymer particles to the surface of the EA toner particles, in embodiments, very good anti-blocking/storage characteristics are enabled, and there is an improvement in maintaining charge to end of life.

### SUMMARY

A toner comprising a core comprising at least one resin and at least one colorant, and having on a surface thereof, an additive package comprising fluorinated polymer particles.

A toner comprising a core comprising at least one resin and at least one colorant, and having on a surface thereof, an additive package comprising polyvinylidene fluoride particles having a particle size of from about 50 to about 500 nm.

Embodiments also include a method of forming toner particles having surface particles attached thereto, wherein the surface particles comprise fluorinated polymer particles, said method comprising aggregating a material comprising at least one resin and at least one colorant to produce toner particles, following aggregation, forming a mixture of the surface particles and the toner particles, and subjecting the mixture to a temperature above the glass transition temperature of the toner particles to coalesce the toner particles, whereby the surface particles become at least partially embedded within the surface of the toner particles.

### BRIEF DESCRIPTION OF THE DRAWINGS

Reference may be had to the accompanying drawings, which include:

FIG. 1 is a photograph showing an example of the surface incorporation of the fluorinated polymer in an embodiment herein.

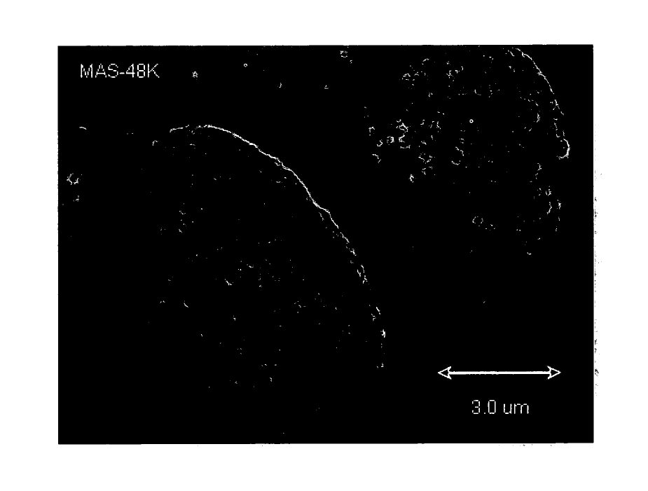

### DETAILED DESCRIPTION

Herein are described toner and developer compositions, and more specifically, color toner and developer compositions containing fluorinated polymer particles as additives. The toner and developer compositions herein, in embodiments, allow for improved maintenance of charge to end of life. In addition, the compositions herein, in embodiments, have improved anti-blocking/storage characteristics. In embodiments, the toner compositions are made via emulsion aggregation (EA) processes.

Emulsion/aggregation/coalescence processes for the preparation of toners are illustrated in a number of Xerox Corporation patents, the disclosures of each of which are totally incorporated herein by reference, such as U.S. Pat. Nos. 5,278,020, 5,290,654, 5,308,734, 5,344,738, 5,346,797, 5,348,832, 5,364,729, 5,366,841, 5,370,963, 5,403,693, 5,405,728, 5,418,108, 5,482,812, 5,496,676, 5,501,935, 5,527,658, 5,585,215, 5,622,806, 5,650,255, 5,650,256, 5,723,253, 5,744,520, 5,747,215, 5,763,133, 5,766,818, 5,804,349, 5,827,633, 5,840,462, 5,853,944, 5,863,698, 5,869,215, 5,902,710, 5,910,387, 5,916,725, 5,919,595, 5,922,501, 5,925,488, 5,945,245, 5,977,210, 6,210,853, 6,395,445, 6,503,680 and 6,627,373.

Thus, as noted above, aggregation and coalescence techniques for forming toner particles are well known in the art, and any suitable aggregation step may be used without limitation. In the aggregation step, toner particles comprising at least one resin and at least one colorant are grown to a desired, predetermined, size, e.g., a size of from about 2 to about 15 microns, from small seed particles of the at least one binder. The starting seed resin particles employed in the aggregation step typically have an average particle size of less than 1 micron, e.g., an average size of from, for example, about 5 to about 500 nm, or from about 10 to about 250 nm in volume average diameter, as measured by any suitable device such as, for example, a NiComp sizer, although larger average sizes may also be used. The seed particles can be polymer materials, and may be formed by any suitable method, such as by creating such polymer materials from starting monomers via the known emulsion polymerization method. Other processes of obtaining the resin seed particles can be selected from polymer microsuspension process, such as disclosed in U.S. Pat. No. 3,674,736, the disclosure of which is totally incorporated herein by reference, polymer solution microsuspension process, such as disclosed in U.S. Pat. No. 5,290,654, the disclosure of which is totally incorporated herein by reference, mechanical grinding process, or other known processes.

In embodiments, the toner particles are derived in an emulsion aggregation process such as in any of the Xerox patents identified above. Broadly, such processes involve emulsion polymerization of polymerizable monomers, generating a latex of seed particles, and to the latex dispersion is added at least one colorant along with other optional additives such as waxes, compatibilizers, releasing agents, coagulants, charge control additives, etc., and the dispersion is aggregated to the desired toner particle size, and then coalesced with heat to obtain the end toner particle.

External additives on the toner surfaces primarily influence toner xerographic performance, such as toner tribo, and the toner's ability to flow properly. The additive presence on the toner surface may increase toner tribo or suppress toner tribo depending, for example, on the toner resin and toner additive selected. A toner with a very low triboelectric value, for example less than about 8 microcoulombs per gram, is very difficult to control xerographically, while a toner with very high tribo, for example greater than about 40 microcoulombs per gram, is difficult to release from the carrier. Therefore, stable tribo in a xerographically appropriate range is desirable. Further, in powder cloud development systems, such as Hybrid Jumping Development, an acceptable level of toner flow (cohesion and adhesion) is desired throughout the imaging process. For example, a toner cohesion in the range of from about 10 percent to about 65 percent, measured using a standard process on a Hosokawa powder tester (Hosokawa Powder Micron Systems, Inc.), is desired throughout the imaging process. Xerographic development in these systems is believed to involve individual toner particles jumping back and forth between roll surfaces and photoreceptor surfaces multiple times, some initiating cascade effects for others. Thus, the adhesion of toner to the roll/photoreceptor, and the cohesion of toner particles to each other as a function of toner residence time in development housing are to be maintained at an acceptable level. As one consequence, additive present on the toner surface should be stable to minimize changes in the state of the toner with variation in solid area coverage. In a developer housing, carrier beads collide with toners and the force from the collision tends to drive the external additives into the toner surface. As the additives are impacted into the toner surface with time, toner tribo and toner flowability will usually change. In an aggressive development housing, toner flowability degrades rapidly, for example with a toner cohesion increasing from a value of less than 15 percent to a value of greater than 75 percent. This occurs under conditions of low toner area coverage of a document, during either xerographic copying or printing, in a period of less than about 1,500 prints. The increase in cohesion of toner particles and adhesion to the donor roll beyond an acceptable threshold level of about 65 percent toner cohesion, leads to loss of development. There is provided herein, in embodiments, a toner surface that withstands the impact of the carrier bead collisions and prevents or limits toner surface additive impaction.

Scanning Electron Microscopy has shown that additives on the surface of known toners have been beaten into the surface of the toner, thereby reducing flow and charging. This leads to print performance problems such as background, mottle, waterfall and other image defects. In addition, the charge has not been maintained to end of life.

In embodiments, a fluorinated polymer particle is added to the surface of the toner. The fluorinated polymer particulates protrude somewhat from the particle surface, thereby acting as spacers that prevent embedding of the external additives necessary for tribo charging and toner flow. This spacer function also minimizes packing or compaction of the toner within the development housing. Toner flow may also be enhanced due to the “slippery” characteristics of some fluoropolymers. The spacer acts to create a “protected” area for the flow additives. This type of protection prevents the additives from being beaten into the surface of the toner particle. These polymers are also quite opaque and will not discolor the toner and therefore, can be used with lighter colors such as yellow and magenta.

In embodiments, the fluorinated polymer particle has a particle size of from about 3 to about 10 micrometers, or from about 3.5 to about 8 micrometers, or from about 4 to about 7 micrometers. The fluorinated polymer particle can be present on the surface of the toner in an amount of from about 0.5 to about 8 percent, or from about 0.75 to about 5 percent, or from about 1 to about 2.25 percent by weight of total solids.

Examples of suitable fluorinated polymer particles include TEFLON®-like materials such as polytetrafluoroethylene (PTFE), fluorinated ethylenepropylene copolymer (FEP), perfluorovinylalkylether tetrafluoroethylene copolymer or perfluoroalkoxy polytetrafluoroethylene copolymer (PFA TEFLON®), polyvinylidene fluoride (KYNAR®), vinylidene fluoride, tetrafluoroethylene, hexafluoropropylene, polymers thereof, ECTFE, a copolymer of ethylene and chlorotrifluoroethylene, copolymers of tetrafluoro ethylene and perfluoroalkoxyvinyl ethers, vinylidene fluoride-hexafluoropropylene, Poly(vinylidene fluoride-co-hexafluoropropylene, perfluoroalkyl polyacrylate copolymer, mixtures thereof, and the like.

The fluorinated polymer particles can be used in combination with one or more additives. For example, other additives include titania such as JMT2000, SMT5103, MT-3102 all available from Tayca Corp., and the like; silica such as, RY50, R812, NY50 all available from Degussa, TG-308F, and TG709 available from Cabot, and the like; and the like additives; and mixtures thereof. In embodiments wherein another additive is added along with the fluorinated polymer particle as a toner additive, the additive has a particle size of from about 8 to about 45, or from about 12 to about 40 nm.

In addition, the fluorinated polymer particles can be used in combination with large additives, such as sol gel additives which include X24 (X-24-0163A) sol gel silica (120-140 nm), cerium oxide (over 100 nm) and the like large additives, and mixtures thereof. In embodiments, the larger additive has a particle size of from about 25 to about 140 nm, or from about 50 to about 120 nm.

The second or additional additives other than the fluorinated polymer particle can be present in an amount of from about 0.1 percent to 5 percent, or from about 1 percent to about 5 percent by weight of the toner.

Examples of suitable toner resins include polyamides, polyolefins, styrene acrylates, styrene methacrylates, styrene butadienes, polyesters such as reactive extruded polyesters, crosslinked styrene polymers, epoxies, polyurethanes, vinyl resins including homopolymers or copolymers of two or more vinyl monomers; and polymeric esterification products of a dicarboxylic acid and a diol comprising a diphenol. Vinyl monomers include styrene, p-chlorostyrene, unsaturated mono-olefins such as ethylene, propylene, butylene, isobutylene and the like; saturated mono-olefins such as vinyl acetate, vinyl propionate, and vinyl butyrate; vinyl esters like esters of monocarboxylic acids including methyl acrylate, ethyl acrylate, n-butylacrylate, isobutyl acrylate, dodecyl acrylate, n-octyl acrylate, phenyl acrylate, methyl methacrylate, ethyl methacrylate, and butyl methacrylate; acrylonitrile, methacrylonitrile, acrylamide; mixtures thereof; and the like; and styrene butadiene copolymers with a styrene content of from about 70 to about 95 weight percent. In addition, crosslinked resins, including polymers, copolymers, and homopolymers of the aforementioned styrene polymers may be selected. In embodiments, styrene butylacrylate resin is used.

Illustrative examples of resins include polymers selected from the group including but not limited to: poly(styrene-alkyl acrylate), poly(styrene-1,3-diene), poly(styrene-alkyl methacrylate), poly(styrene-alkyl acrylate-acrylic acid), poly(styrene-1,3-diene-acrylic acid), poly(styrene-alkyl methacrylate-acrylic acid), poly(alkyl methacrylate-alkyl acrylate), poly(alkyl methacrylate-aryl acrylate), poly(aryl methacrylate-alkyl acrylate), poly(alkyl methacrylate-acrylic acid), poly(styrene-alkyl acrylate-acrylonitrile-acrylic acid), poly(styrene-1,3-diene-acrylonitrile-acrylic acid), poly(alkyl acrylate-acrylonitrile-acrylic acid, poly(styrene-butadiene), poly(methylstyrene-butadiene), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methylstyrene-isoprene), poly(methyl methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene), and poly(butyl acrylate-isoprene), poly(styrene-propyl acrylate), poly(styrene-butyl acrylate), poly(styrene-butadiene-acrylic acid), poly(styrene-butadiene-methacrylic acid), poly(styrene-butadiene-acrylonitrile-acrylic acid), poly(styrene-butyl acrylate-acrylic acid), poly(styrene-butyl acrylate-methacrylic acid), poly(styrene-butyl acrylate-acrylononitrile), poly(styrene-butyl acrylate-acrylononitrile-acrylic acid), poly(para-methyl styrene-butadiene), poly(meta-methyl styrene-butadiene), poly(alpha-methyl styrene-butadiene), poly(para-methyl styrene-isoprene), poly(meta-methyl styrene-isoprene), poly(alpha-methyl styrene-isoprene), poly(methylacrylate-styrene), poly(methylacrylate-styrene), poly(methylmethacrylate-styrene).

Further illustrative examples of resins include polyethylene-terephthalate, polypropylene-terephthalate, polybutylene-terephthalate, polypentylene-terephthalate, polyhexalene-terephthalate, polyheptadene-terephthalate, polyoctalene-terephthalate. Sulfonated polyesters such as sodio sulfonated polyesters as described in, for example, U.S. Pat. No. 5,593,807, may also be used. Additional resins, such as polyester resins, are as indicated herein and in the appropriate U.S. patents recited herein, and more specifically, examples further include copoly(1,2-propylene-dipropylene-5-sulfoisophthalate)-copoly(1,2-propylene-dipropylene terephthalate), copoly(1,2-propylene-diethylene-5-sulfoisophthalate)-copoly(1,2-propylene-diethylene terephthalate), copoly(propylene-5-sulfoisophthalate)-copoly(1,2-propylene terephthalate), copoly(1,3-butylene-5-sulfoisophthalate)-copoly(1,3-butylene terephthalate), copoly(butylenesulfoisophthalate)-copoly(1,3-butylene terephthalate), and the like. In embodiments, the resin is a styrene butylacrylate resin.

The resin particles selected for the process herein can be prepared from emulsion polymerization techniques, and the monomers used in such processes can be selected from the group consisting of styrene, acrylates, methacrylates, butadiene, isoprene, and optionally acid or basic olefinic monomers such as acrylic acid, methacrylic acid, acrylamide, methacrylamide, quaternary ammonium halide of dialkyl or trialkyl acrylamides or methacrylamide, vinylpyridine, vinylpyrrolidone, vinyl-N-methylpyridinium chloride and the like. The presence of acid or basic groups is optional. Crosslinking agents such as divinylbenzene or dimethacrylate and the like, can also be selected in the preparation of the emulsion polymer. Chain transfer agents, such as dodecanethiol or carbontetrachloride and the like, can also be selected when preparing resin particles by emulsion polymerization.

The resin particles selected, which generally can be in embodiments polystyrene homopolymers or copolymers, polyacrylates or polyesters, are present in various effective amounts, such as from about 50 weight percent to about 98 weight percent of the toner. Other effective amounts of resin can be selected.

External additive particles in addition to the fluorinated polymer particle, and including flow aid additives, can be used. These additives may also be on the surface of the toner. Examples of these additives include colloidal silicas, such as AEROSIL, metal salts and metal salts of fatty acids, such as zinc stearate, metal oxides such as aluminum oxides, cerium oxides, titanium oxides, and mixtures thereof. The additives are generally present in an amount of from about 0.1 percent by weight to about 5 percent by weight, or in an amount of from about 0.1 percent by weight to about 3 percent by weight, or from about 1.6 to about 3 percent by weight, or about 2 percent by weight. Several of the aforementioned additives are illustrated in U.S. Pat. Nos. 3,590,000 and 3,800,588, the disclosures of which are totally incorporated herein by reference.

The toner compositions can include waxes, such as low molecular weight waxes. Examples include polypropylenes and polyethylenes, such as those commercially available from Allied Chemical and Baker Petrolite Corporation, EPOLENE N-15 commercially available from Eastman Chemical Products, Inc., VISCOL 550-P, a low weight average molecular weight polypropylene available from Sanyo Kasei K.K., and similar materials. The polyethylenes can have a molecular weight of from about 600 to about 1,500, and polypropylenes can have a molecular weight of from about 4,000 to about 7,000. A specific example is Polywax 725 from Baker Petrolite. The low molecular weight wax materials can be present in the toner composition in an amount of from about 1 to about 15 percent by weight or have from about 2 to about 10 percent by weight.

The toner compositions can be colored toner and developer compositions comprising pigments or colorants of black, red, blue, green, brown, magenta, orange, cyan and/or yellow particles, as well as mixtures thereof. Examples of magenta materials include 2,9-dimethyl-substituted quinacridone and anthraquinone dye identified in the Color Index as CI 60710, CI Dispersed Red 15, diazo dye identified in the Color Index as CI 26050, CI Solvent Red 19, and the like. Illustrative examples of cyan materials include copper tetra-4-(octadecyl sulfonamido) phthalocyanine, X-copper phthalocyanine pigment listed in the Color Index as CI 74160, CI Pigment Blue, and Anthrathrene Blue, identified in the Color Index as CI 69810, Special Blue X-2137, and the like. Examples of yellow pigments include diarylide yellow 3,3-dichlorobenzidene acetoacetanilides, a monoazo pigment identified in the Color Index as CI 12700, CI Solvent Yellow 16, a nitrophenyl amine sulfonamide identified in the Color Index as Foron Yellow SE/GLN, CI Dispersed Yellow 33, 2,5-dimethoxy-4-sulfonanilide phenylazo-4′-chloro-2,5-dimethoxy acetoacetanilide, and Permanent Yellow FGL. Carbon black, such as Regal 330, can be used as the black colorant or pigment. The pigments can be present in the toner composition in an amount of from about 2 to about 15 percent by weight, based on the weight of the toner resin particles.

In developer compositions herein, carrier particles can be added. Examples of carrier particles include iron powder, steel, nickel, iron, ferrites, including copper zinc ferrites, and the like. Carrier particles can be used with or without a coating, the coating generally containing terpolymers of styrene, methylmethacrylate, and a silane, such as triethoxy silane; polymethyl methacrylates; other known coatings; and the like. The carrier coating can be present in an amount of from about 0.1 to about 3 weight percent, or conductive particles of carbon black in an amount of from about 5 to about 30 percent by weight. Polymer coatings not in close proximity in the triboelectric series can also be selected, for example, KYNAR® and polymethylmethacrylate mixtures (40/60). Coating weights can vary as indicated herein; generally, however, from about 0.3 to about 2, or from about 0.5 to about 1.5 weight percent coating weight is selected.

The carrier particles can be any shape, and in embodiments, are spherical in shape. The carrier is from about 50 to about 500, microns or from about 75 to about 125 microns thereby permitting them to possess sufficient density and inertia to avoid adherence to the electrostatic images during the development process. The carrier component can be mixed with the toner composition in various suitable combinations, such as from about 1 to about 5 parts per toner to about 100 parts to about 200 parts by weight of carrier.

The following Examples are intended to illustrate and not limit the scope herein. Parts and percentages are by weight unless otherwise indicated.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

### EXAMPLES

### Example 1

Preparation of Base Toners

The following base toner of Table 1 below was made for testing.

TABLE 1

| | Amount |
|---|---|
| Ingredient | in grams |
| Deionized Water | 873.18 |
| Pigment K24 Tayca Regal 330 (carbon black) | 88.65 |
| Core Latex | 420.54 |
| Polyvinylidene fluoride (KYNAR ®), | 78.80 |
| Spacers - 363 nm) | |
| Polyethylene wax (P725 from Baker Petrolite) | 82.67 |
| Polyaluminum chloride (PAC) (coagulating agent) | 4.95 |
| HNO₃ - 0.2 M | 44.55 |
| Shell Latex | 194.94 |

Typical E/A formulations using styrene/butylacrylate resin (or other suitable resins) are made by first homogenizing then mixing the resin, pigment, polyethylene wax, polyaluminum chloride (or other coagulating agent) at a temperature at or above the Tg of the resin. The mixture is grown to the desired size. The first outer shell is then added until gone then the second shell containing the fluorinated polymer (Kynar) is added. The particles are further heated until the appropriate particle size (about 6-8 um depending upon the program requirement) is reached, and then growth is halted with the addition of a base such as sodium or ammonium hydroxide. The particles are then coalesced at an elevated temperature (about 95-100° C.) until a suitable shape and morphology is obtained (depending upon the amount of fluorinated protrusions desired on the surface of the particle and the shape of the particle). Particles are then wet sieved, washed by filtration, and subsequently dried. The actual lab scale formulations are found in Table 1. The resultant parent toner particles flowed well and did not settle as is seen in the current SCD formulation.

General emulsion polymer formulation: The polymer selected for the process can be prepared by emulsion polymerization methods. The monomers used in such processes include, for example, styrene, acrylates, methacrylates, butadiene, isoprene, acrylic acid, methacrylic acid, itaconic acid, beta carboxy ethyl acrylate, acrylonitrile, and the like. Known chain transfer agents, for example dodecanethiol, from, for example, about 0.1 to about 10 percent, or carbon tetrabromide in effective amounts, such as from about 0.1 to about 10 percent, can be used to control the molecular weight properties of the polymer when emulsion polymerization is selected. Other processes of obtaining polymer particles of from, about 0.01 micron to about 2 microns can be selected from polymer microsuspension process, such as disclosed in U.S. Pat. No. 3,674,736, the disclosure of which is totally incorporated herein by reference; polymer solution microsuspension process, such as disclosed in U.S. Pat. No. 5,290,654, the disclosure of which is totally incorporated herein by reference, mechanical grinding processes, or other known processes. Also, the reactant initiators, chain transfer agents, and the like as disclosed in U.S. Pat. No. 922,437, and the like, the disclosures of which are totally incorporated herein by reference, can be selected for the processes herein. The emulsion polymerization process may be accomplished by a batch process (a process in which all the components to be employed are present in the polymerization medium at the start of the polymerization) or by continuous emulsification process. The monomer(s) can also be fed neat or as emulsions in water.

Emulsion polymerization is usually performed by heating, for example, at a temperature of from about 25 to about 120° C., or from about 50 to about 95° C. and wherein for the reaction there is included initiators, such as azo polymerization initiators, with a solubility of greater than about, or about equal to 0.05 grams, or from about 0.5 grams per liter of monomers at 25° C. in the monomer mixture, or water, and with an appropriate half life at the temperature of polymerization. Appropriate half-life refers for example, to a half-life of about 1 to about 4 hours. Typical examples of such initiators, are azocumene, 2,2′-azobis(isobutyronitrile), 2,2′-azobis(2-methyl)butanenitrile, 4,4′-azobis(4-cyanovaleric acid), 2,2′-azobis)2-methyl-N-(2-hydroxyethyl)!-propionamide, 2,2′-azobis)2-methyl-N-1,1-bis(hydroxymethyl)2-(hydroxyethyl)!-propionamide, and 2-(t-butylazo)2-cyanopropane. Other soluble non-azo initiators with an appropriate half-life may also be used, including, among others, benzoyl peroxide, lauroyl peroxide, molecular hydrogen, and sodium, potassium or ammonium persulfates. An effective concentration of the initiator generally employed is, for example, from about 0.05 to about 10 percent by weight, or from about 0.2 to about 5 percent by weight of monomers used to prepare the polymer, or copolymer resin. Redox initiator systems can also be used, such as redox pairs like ammonium persulphate/sodium metabisulphite. An effective concentration of the redox initiator generally employed is, for example, from about 0.01 to about 10 percent by weight, or from about 0.05 to about 3 percent by weight of monomers in the reaction mixture.

To ensure maximum catalyst activity the emulsion polymerizations can be accomplished in the substantial absence of oxygen under an inert atmosphere, such as nitrogen, argon or other non-oxidizing gas.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

What is claimed is:

1. A toner comprising a core comprising at least one resin and at least one colorant, and having on a surface thereof, an additive package comprising fluorinated polymer particles.

2. A toner in accordance with claim 1, wherein said fluorinated polymer particle has a particle size of from about 3 to about 10 micrometers.

3. A toner in accordance with claim 2, wherein said particle size is from about 3.5 to about 8 micrometers.

4. A toner in accordance with claim 1, wherein said fluorinated polymer particles comprise a fluoropolymer selected from the group consisting of polytetrafluoroethylene, fluorinated ethylenepropylene copolymer, perfluorovinylalkylether tetrafluoroethylene copolymer, perfluoroalkoxy tetrafluoroethylene copolymer, polyvinylidene fluoride, vinylidene fluoride, tetrafluoroethylene, hexafluoropropylene, polymers thereof, and mixtures thereof.

5. A toner in accordance with claim 4, wherein said fluoropolymer is polyvinylidene fluoride.

6. A toner in accordance with claim 1, wherein said fluorinated polymer particles are present on the surface of said toner in an amount of from about 0.5 to about 8 percent by weight of the toner.

7. A toner in accordance with claim 6, wherein said fluorinated polymer particles are present on the surface of said toner in an amount of from about 0.75 to about 5 percent by weight of the toner.

8. A toner in accordance with claim 7, wherein said fluorinated polymer particles are present on the surface of said toner in an amount of from about 1 to about 2.25 percent by weight of the toner.

9. A toner in accordance with claim 1, wherein said additive package further comprises a second additive.

10. A toner in accordance with claim 9, wherein said second additive has a particle size of from about 8 to about 45 nm.

11. A toner in accordance with claim 9, wherein said second additive has a particle size of from about 25 to about 140 nm.

12. A toner in accordance with claim 9, wherein said second additive is selected from the group consisting of silica, titania, zinc stearate, cerium oxide, and mixtures thereof.

13. A toner in accordance with claim 12, wherein said second additive comprises a mixture of silica and titania.

14. A toner in accordance with claim 9, wherein said second additive is present in an amount of from about 0.1 to about 5 weight percent by weight of toner.

15. A toner in accordance with claim 1, wherein said resin is selected from the group consisting of polyester, styrenes, acrylates, vinyls, polymers thereof, and mixtures thereof.

16. A toner in accordance with claim 1, wherein said resin is a styrene butylacrylate.

17. A toner in accordance with claim 1, wherein said toner further comprises a colorant selected from the group consisting of black, red, blue, yellow, green, brown, orange, cyan, magenta, and mixtures thereof.

18. A developer comprising a carrier and the toner of claim 1.

19. A toner comprising a core comprising at least one resin and at least one colorant, and having on a surface thereof, an additive package comprising polyvinylidene fluoride particles having a particle size of from about 50 to about 500 nm.

20. A method of forming toner particles having surface particles attached thereto, wherein the surface particles comprise fluorinated polymer particles, said method comprising aggregating a material comprising at least one resin and at least one colorant to produce toner particles, following aggregation, forming a mixture of the surface particles and the toner particles, and subjecting the mixture to a temperature above the glass transition temperature of the toner particles to coalesce the toner particles, whereby the surface particles become at least partially embedded within the surface of the toner particles.
